(19) United States
(12) Patent Application Publication
(10) Pub. No.: US 2010/0161462 A1
(43) Pub. Date: Jun. 24, 2010

(54) TIME AND ACTIVITY TRACKING SYSTEM

(75) Inventors: Anthony H. Pappas, Woodland Hills, CA (US); Eric R. Renken, Niles, MI (US); Scott K. Prewett, Woodland Hills, CA (US); Valerie L. Doran, Woodland Hills, CA (US); John O'Hara, Moorpark, CA (US); Myles Christensen, Pueblo West, CO (US); John Milligan, Camarillo, CA (US)

Correspondence Address: KELLY LOWRY & KELLEY, LLP, 6320 CANOGA AVENUE, SUITE 1650, WOODLAND HILLS, CA, 91367, US

(73) Assignee: EXAKTIME INNOVATIONS, INC., Calabasas, CA (US)

(21) Appl. No.: 12/338,942

(22) Filed: Dec. 18, 2008

(51) Int. Cl. G06Q 10/00

(52) U.S. Cl. 705/32

(57) ABSTRACT

A time and activity tracking system includes a hand-held device storing unique codes for a plurality of activities. A user can select an activity from the plurality of activities stored in the memory, and transmit the unique code to an electronic time clock, which associates a time stamp with the codes. The activities can include clocking in, clocking out, or various work activities or projects of the user.

### BACKGROUND OF THE INVENTION

The present invention generally relates to time clocks and time-keeping apparatuses. More particularly, the present invention relates to a system for tracking time and activities of employees utilizing a hand-held device for selecting from a list of activities and an electronic time clock which stores a unique code representing employee information and selected activity data, and related time stamps.

It is common practice for employees to “clock in” and “clock out” when checking in and checking out of work, such as when arriving at work, taking a lunch break and leaving for the day. The use of time clocks for tracking the time when an employee checks in and checks out is commonplace.

However, an employee or supervisor must collect the time cards at the end of the shift or work period, usually every week or two, and calculate the hours worked each day for each employee. This is a time-consuming and expensive task. Moreover, in some work environments, such as a construction job site, it is difficult to monitor when employees check in and check out. This is due to the fact that such work sites are often outdoors and not conducive to traditional time clock apparatuses. A company could lose thousands of dollars per year when employees arrive about fifteen minutes late and leave fifteen minutes early, but do not reflect it on the written time sheets.

Applicant, Exaktime, Inc., currently offers a time attendance clock (JobClock™) which is particularly suited for outdoor use, such as at job construction sites and the like, and which overcomes the aforementioned drawbacks. This electronic time clock includes a touch button or Keytab™ detector, which detects Keytabs™ moved into contact with the detector and which are owned by each employee. When the touch button or Keytab™ is brought into contact with the clock, the identity of the employee and the time is saved in an electronic record. Checking in and checking out can be tracked over time. Typically, the employee has different colored Keytabs™ which indicate “in” or “out”. In this manner, as the employee checks in for the day, checks out for lunch, checks back in to work, takes breaks, etc., can be tracked.

The Keytabs™ or touch buttons comprise a small hand-held, typically plastic, finger tabs having a Dallas/Maxim iButton™ at and end thereof. The iButton™ consists of a metallic can having an integrated circuit chip therein programmed with a unique identification code representing that integrated circuit chip. The unique identification code can be associated with each employee, such that the different Keytabs™ are associated with the individual, such as checking in or checking out. The Keytab, when touched to the electronic clock, passes a modulated current therebetween which contains the unique identification number, which is read and stored in the clock, along with the date and time at the precise moment that the Keytab™ was touched.

Workers are typically told to keep their Keytabs™ on their personal key rings, thus making them difficult to forget. In the most common scenario, a green Keytab™ is assigned to “in” and a red Keytab™ is “out”. By touching red and green to the clock throughout the day, labor hours can be tracked.

However, many businesses desire to track the nature of the work being performed at a more granular level. In and out is insufficient to accurately track the type of labor being performed. Furthermore, accurately assigning the type of activity being performed improves job costing, which is the practice of accurately determining how much of each type of labor was performed in a particular project.

Moreover, workers compensation costs can be reduced by accurately tracking labor activities. Many states require the highest burden rate to be assigned to all labor hours worked, if accurate electronic timekeeping mechanisms are not used. This has significance in the bottom line, for example, if half of the labor hours are roofing work, and half are clean-up. If there isn't an electronic timekeeping in place, then all labor hours will be assessed at the drastically more expensive roofing work rate.

With the existing JobClock™ system of Exaktime, Inc., these labor hours are tracked with additional colors of Keytabs™. For example, in the morning, a worker might touch the brown “roofing” work Keytab™, followed by a blue “clean-up” Keytab™, then touch a yellow “travel” Keytab™, when they drive to another job site. Subsequently, they might touch a tan “brickwork” Keytab™, then finally a red “out” Keytab™ at the end of the day.

It will be appreciated that in some instances the number of Keytabs™ representing the different types of duties the worker might perform daily or periodically can be quite numerous. Applicant has discovered that there is a practical limit to the number of Keytabs™ that a worker is willing to carry on his or her key ring and use throughout the day, typically five or less. More than that on the worker's personal key ring becomes bulky and difficult to store in their pocket.

However, workers can, over the span of a project, perform dozens and dozens of activities, all needing to be tracked. It is impractical and complicated to reassign Keytabs™ from employee to employee and from activity to activity. As a result, workers are limited, from a practical point of view, in the number of activities they can track.

Accordingly, there is a continuing need for a method and system of tracking both an employee's time and the various activities that an employee may perform throughout a day or given pay period. Such a system should be capable of storing a large number of activities for any given employee, while not requiring the employee to carry a large number of Keytabs™. The present invention fulfills these needs, and provides other related advantages.

### SUMMARY OF THE INVENTION

The present invention resides in a time and activity tracking system, and related method, which overcomes the drawbacks noted above. The system includes a hand-held device which comprises an electronic circuit, including a memory storing a plurality of unique codes, each code representing the identity of the hand-held device or user as well as an activity, such that the hand-held device takes the place of the use of multiple Keytabs™. An actuator of the device is adapted to select an activity from the plurality of activities stored in the memory. Typically, the hand-held device includes a scroll wheel which is adapted to scroll through a list of activities.

The hand-held device includes a display for displaying a human readable activity as the activity is selected. This may be done by means of illustrating each activity as the list of activities is scrolled through. As such, the display typically comprises a single line display for displaying a single selected activity at a time.

The hand-held device includes a data transmitter for transmitting the selected unique code. The data transmitter typically comprises a conductive member adapted to be placed in direct contact with a receiver of the time clock to transmit the identification and activity codes. The conductive member may comprise a metallic can having a data contact in conductive connection with a lid or base of the can, and a ground contact in conductive connection with the corresponding lid or base of the can.

The electronic time clock comprises a data receiver for receiving the unique code transmitted by the hand-held device. Typically, the time clock includes a conductive receptor adapted for direct contact with the conductive member of the hand-held device for the transfer of data between the hand-held device and the time clock. The electronic time clock also includes an internal clock, and means for associating a time stamp with the received unique code as a file. The electronic time clock stores the received unique code and related time stamps in the memory thereof.

In accordance with the present invention, periodically, the files are transferred from the electronic clock to a billing processor, which creates time and activity records for each identification code, or employee, over a predetermined period of time.

In use, an activity from the plurality of activities is selected using the actuator of the device. This is typically done, as indicated above, by rotating a scroll wheel to select an activity from a list of activities. The selected activities are displayed on a display of the device in human readable text.

The selected unique code is transmitted to the electronic time clock. This is typically done by moving the conductive transmitter member of the hand-held device into contact with the conductive receiver member of the electronic time clock.

The electronic time clock associates a time stamp representing the exact date and time when the selected unique code was transmitted from the hand-held device to the electronic clock. These are stored as a file in the memory of the electronic clock. Periodically, the stored files are transferred from the electronic time clock to the central billing processor, for creating time and activity records relating to each identification code/employee over a predetermined period of time.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a side perspective view of a hand-held virtual Keytab™ device embodying the present invention;

FIG. 2 is a side perspective view, illustrating a scroll wheel actuator thereof being rotated;

FIG. 3 is a perspective view illustrating the hand-held device in alignment with an electronic time clock, in accordance with the present invention;

FIG. 4 is a perspective view similar to FIG. 3, illustrating a conductive data transmitter member of the hand-held device moved into contact with a receiver of the electronic time clock;

FIG. 5 is a diagrammatic view illustrating the selection of an activity from an exemplary list of activities, in accordance with the present invention; and

FIG. 6 is a diagrammatic view illustrating various components of the system of the present invention.

### DETAILED DESCRIPTION OF THE PREFERRED EMBODIMENTS

As shown in the accompanying drawings, for purposes of illustration, the present invention resides in a device for use in a system for tracking time and activities, such as in a work environment. As will be more fully described herein, the present invention enables a worker to not only clock in and clock out, but rather to select an activity, such as a particular work activity or project, and track the time for that particular activity or project. The device of the present invention can store a large number of such activities or projects such that the worker can carry a single device and yet track the time for many different activities over the course of a day, week, etc.

The term “activity” is used herein in a general and broad sense so as to cover the various types of job sites, jobs, duties, work activities, projects, etc. that workers of various industries may encounter. The present invention is particularly adapted for use in the construction industry. As such, as the worker performs different duties within a day, works on different projects, etc., all of these activities can be tracked and appropriately billed. For example, the worker may need to bill for travel time, brickwork, clean-up, prep work, floors, finish work, plumbing, roofing work, framing, etc. Each of these activities may be billed out at a different cost code or rate. Moreover, an employee may desire to track the one or more activities he or she performs between different work projects or locations. Although the present invention will be described herein primarily using the example of a construction worker, it will be appreciated that the invention is not limited to such. For example, the hand-held device of the present invention may be carried by a supervisor, who clocks in and out or selects different job activities for the different employees which serve under him. The system of the present invention may be also used in a job shop, such as a manufacturing floor, where the locations of activities to be performed are stationary, often tied to a large physical machine, which cannot be easily moved, while the jobs are throughout the shop. An example would be a cabinet making facility, wherein the first station is where the frame of the wood cabinet is cut, a second station is where the wood is to be glued and nailed together, another station is where the wood is sanded, another station where the wood objects are primed and stained, etc. In these cases, an electronic clock can be mounted at each station which represents the activity at that particular station. As the project and/or employees move from station to station, the system of the present invention enables accurate cost determination and billing, both for the employees as well as for the project itself. It will be appreciated that the system of the present invention could be used in other workplaces and fields as well.

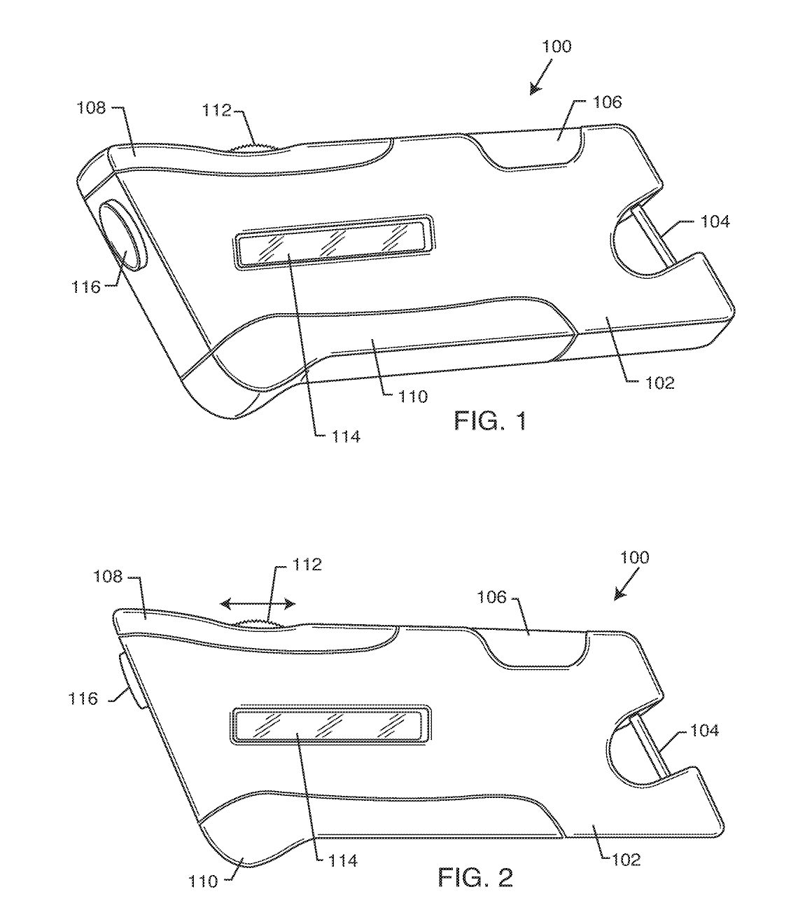

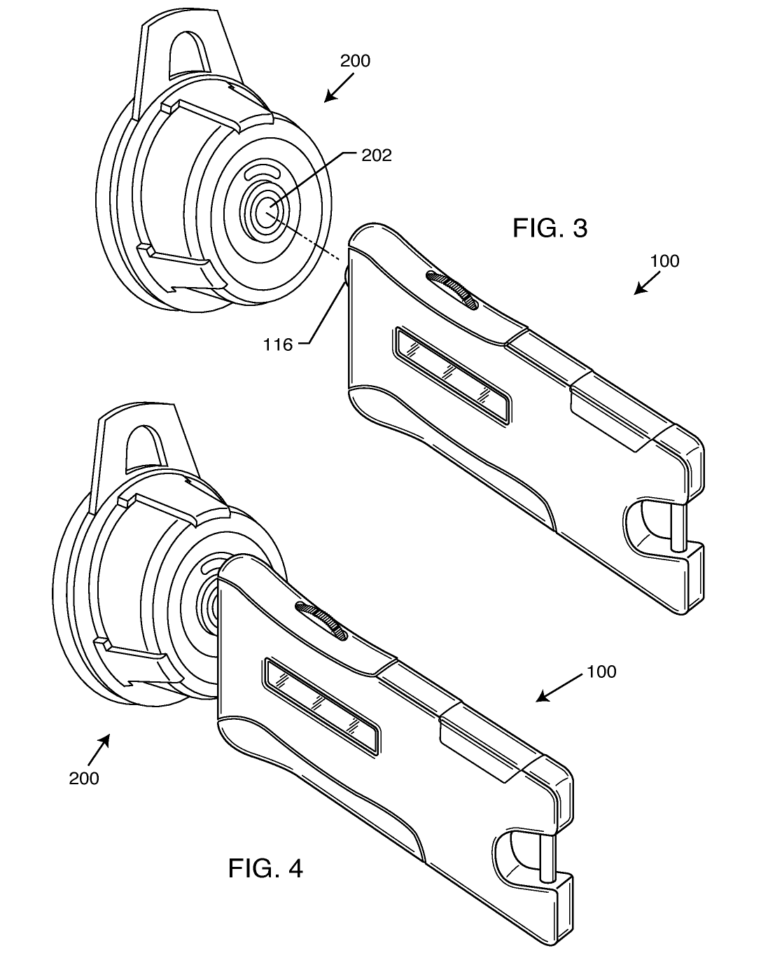

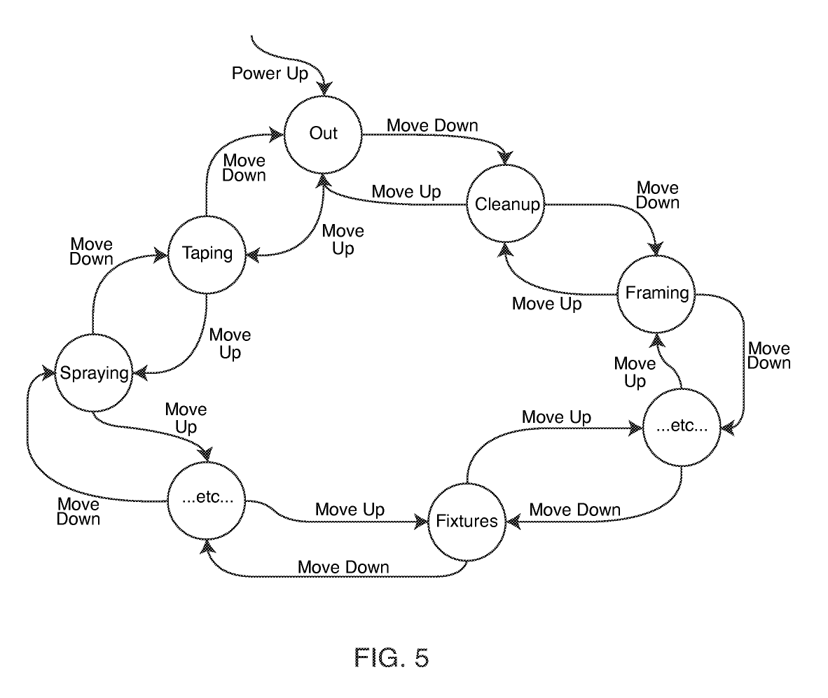

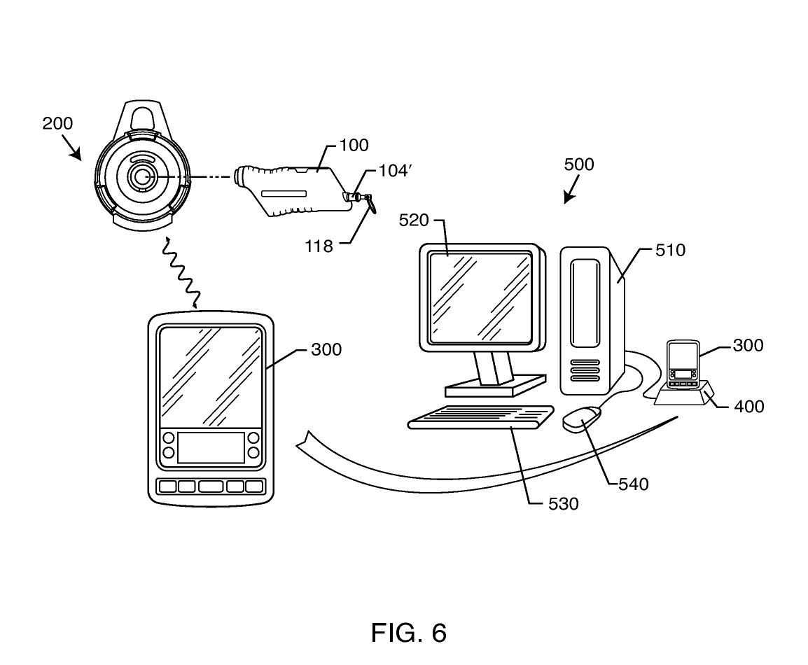

With reference now to FIGS. 1 and 2, the present invention is in the form of a hand-held and portable device 100. The device includes a housing 102 which is sized so as to be easily carried and handled by a single hand of a user, and preferably hung on a belt, belt loop, or even on a key ring of the user. As such, the housing 100 includes a key ring attachment member 104′, for removable attachment to a key ring or the like. Other arrangements for attachment to a key ring are also contemplated. For example, as illustrated in FIG. 6, the hand-held device 100 includes a quick-connect key ring attachment member 104, to which a key ring 118 is releasably attached. Thus, the worker can remove the device 100 from his or her key ring when not at the workplace.

Preferably, the housing 102 is ergonomic in nature so as to be comfortably held by the user. As such, the housing may include gripping material 106-110 at key locations thereon such that the user can easily grasp and hold the housing 102. Such gripping material may comprise elastomeric material, such as a rubber-based compound or the like.

Within the housing 102 is an electronic circuit, not shown, which includes a memory for storing a unique identification code for the device 100 and codes for a plurality of activities. A power source, such as a battery, is in electrical communication with the electronic circuit and memory. Preferably, the battery has an ideal battery life of several months, and may comprise an off-the-shelf easily obtainable battery such as a AAA battery, a lithium CR2 battery or the like. Preferably, the battery is replaceable, although it will be appreciated that the battery and device may be rechargeable.

The device will be programmed with unique codes and corresponding text via an interface. Each code is unique and represents an assigned activity as well as a user or the hand-held device, whichever is applicable. Thus, in the preferred embodiment, each hand-held device will have a plurality of unique codes which are not present in any other hand-held device, and all of which have corresponding employee, user, or hand-held device, and activity-related information. Of course, it is contemplated by the present invention that a hand-held device or user identification code be associated with a code assigned to each activity as well. However, the tracking of multiple codes combined or associated with one another becomes much more complicated. The interface may be wireless, but is more typically of a wired variety, such as HID USB interface. Upon initiation of communications, the device 100 will accept a read command and will reply with a complete list of unique codes and corresponding text loaded on to the device. The device will accept a series of commands to write the virtual serial number and the corresponding text to the device. The list of activities and associated codes can be modified and replaced as needed.

By means of example, a given activity may require six bytes as the virtual serial number element, and the human readable activity description may take fifty bytes, for a total of fifty-six bytes. With 48 bits of precision, more than 280 trillion unique activities can be listed and programmed. Of course, the exact number of activities and storage requirements can be subject to the discretion of the designer. However, it will be appreciated that the device can store dozens, if not thousands, of different activities to be selected.

Aside from the various activity codes, the device 100 itself may have a unique code. This can include a family code, which may be programmed to be 01 so as to insure compatibility with other devices, particularly existing Dallas/Maxim devices. A static or fixed device serial number is also either programmed into the device or included in a Dallas/Maxim iButton™ incorporated therein. Typically, the unique identification code is hard coded into the device and may include forty bits, constituting the static device serial number and the device firmware version. As described above, eight bits may be used for each dynamic unique code or serial number.

Typically, the device 100 is relatively simple in nature in that it includes a predetermined list of activities which can be viewed and selected by the user. The selection of an activity of the list of activity codes (and related human readable text) is done by means of an actuator 112. Although it will be appreciated that the actuator 112 can comprise a button, lever, a plurality of buttons, etc., in a particularly preferred embodiment the actuator 112 comprises a scroll wheel, as illustrated. The scroll wheel is rotatable back and forth so as to move through the list of activities. Such activities, using a construction job site example, can include:
Out
Clean-Up
Coating
Demolition
Drywall
Finishing
Fixtures
Formwork
Framing
Pouring
Rough-in
Sanding
Spraying
Taping

The user would utilize the scroll wheel in scrolling through the list of activities. For example, upon initiation, the “out” activity is selected. Upon scrolling down the list one step, the “clean-up” activity or task would be selected. However, scrolling in reverse could move the user to the “taping” activity in the list.

The device 100 includes a display 114 for displaying the selected activity. Typically, as indicated above, the activity is programmed as a code in the device. However, an associated human readable text is associated with the code, and displayed on the display 114. In a particularly preferred embodiment, the display 114 comprises a single line display, such that only a single activity at any given time is displayed on the display as the scroll wheel actuator 112 is activated. If the length of the text description exceeds the display window 114, the device can be programmed so as to horizontally scroll the entire text description. Thus, it will be appreciated that as the user scrolls through the list of activities, the activities are sequentially displayed visually by means of display 114.

With reference now to FIG. 5, a diagrammatic view is provided showing the scrolling and selecting through an exemplary list of activities. On power-up, such as by activating the actuator, such as rotating the scroll wheel, a given activity will be displayed. This could be the last activity that was selected by the user, or a default activity, such as the “out” activity. FIG. 5 illustrates scrolling from “out” to “clean-up”, to “framing”, etc. As the scroll wheel 112 is rotated, each of the activities will be sequentially shown in the display 114. To select an activity, the user ceases scrolling or moving the actuator 112, such that the text of the activity remains in the display window 114.

Due to the fact that it can be unwieldy to sift through large numbers of activity codes, and related text, on the device, the device may be programmed with a hierarchal categorization method which lets the user bundle together common groups of activities based on their own criteria. These could be “favorites”, “plumbing”, or the like. It is contemplated by the present invention that the most often used activities are displayed first, which can either be programmed into the device or the device can be programmed so as to recognize which activities have been recently selected and move those activities towards the top of the list such that the user need not unnecessarily sift and scroll through the list to find such activities.

As mentioned above, an activity may be selected by merely ceasing activation of the actuator 112, thus the text of the activity remaining in the display 114. It is also contemplated by the present invention that the actuator be used to actually select the activity, such as by depressing a lever, button, scroll wheel, etc.

In any event, once the appropriate activity has been selected, the hand-held device 100 is moved towards the electronic time clock 200, such that a data transmitter, in the form of a conductive member 116 extending from the housing is aligned with a receiver, in the form of a conductive receptor 202 of the electronic clock 200. In a particularly preferred embodiment, the hand-held device 100 is moved such that the data transmitter conductive member 116 actually comes into direct contact with the conductive receptor 202 of the electronic clock 200, such that the data can be transferred between the hand-held device 100 and the electronic clock 200.

In a particularly preferred embodiment, the data transmitter 116 comprises a metallic can having an integrated circuit therein. A data contact of the integrated circuit is in conductive connection with a lid or base of the can, and a ground contact is in conductive connection with the corresponding lid or base of the can. Such is the case of the well-known iButton™, produced and sold by Dallas/Maxim. Similar to touching the iButton™ portion of a Keytab™ onto the touch button receptor of the electronic clock to transfer data to the electronic clock, the conductive member 116 serves the same purpose and is recognized by the receptor 202 of the time clock 200 as essentially being an iButton™ of a Keytab™. However, instead of transmitting a single code in the form of a modulated signal, the device 100 of the present invention sends the selected unique code, in the form of a modulated signal, to the electronic clock 200 via the direct contact between the data transmitter member 116 and the receiver conductive receptor 202. In this manner, the hand-held device 100 serves as a virtual Keytab™, and can send any one of the previously programmed activity codes to the electronic time clock 200, as selected.

Once the unique code has been transmitted, the electronic clock will give a visual and/or audible indication that the transmission has occurred. This enables the worker to verify that the clocking in for the particular activity, or clocking out, has occurred and has been recorded. The electronic clock 200, as disclosed in U.S. Pat. No. 7,298,673, the contents of which are incorporated herein by reference, includes an electronic circuit, a power source, a time stamping clock, and a memory for creating and storing files comprising the transmitted unique code corresponding to the hand-held device or employee, and the selected activity, as well as a time stamp indicating the exact date and time when this transmission occurred.

Although the electronic clock 200 typically includes an internal clock and means for creating and associating a time stamp with the transmitted codes, it is contemplated by the invention that the hand-held device 100 include an internal clock. This internal clock may contain an RTC (real-time-clock), so as to set the electronic time clock's clock to a designated real time to avoid drift. Alternatively, the hand-held device 100 can include an internal clock which creates a time stamp indicating the date and time when the data is transferred, such that the electronic clock 200 merely needs to receive and store the record.

With reference now to FIG. 6, the files which have been accumulated and stored on the electronic time clock 200 are periodically copied or pulled and transferred to a billing processor. Typically, this is done by means of a hand-held personal digital assistant 300, such as a Palm Pilot™. However, the hand-held device 100 of the present invention can be programmed and designed so as to have the function of copying or removing the stored files 200, each of which include a time stamp, and a unique code, for transfer to the central processor 500. This is done periodically, such as every week or two, so as to create time attendance records. As such, the files are downloaded from the electronic clock 200, for the creation of individual time attendance records, reflecting the individual user or employee and the activities throughout each day or time period that the worker performed.

As more fully described in U.S. Pat. No. 7,298,673, the personal digital assistant 300 downloads the files from the electronic clock 200 using a communication protocol, such as an IrDA, which is an industry standard for many personal digital assistants. In this manner, the electronic clock 200 can communicate with a wide variety of hand-held devices 300 using standard communication protocols including, but not limited to, IrDA, BlueTooth, USB, etc. The hand-held personal digital assistant 300, or the hand-held device 100, is then interfaced with a computer, constituting the central billing processor 500, which may take the form of a laptop or desktop computer 510, having a display 520, keyboard 530, a mouse 540, or any other necessary peripheral items. A docketing station 400, or wired or wireless connection may be used for transferring the individual files from the personal digital assistant 300 (or hand-held device 100) to the processor 510 of the computerized billing system 500. The files are then downloaded into a software program stored on the computer 500 for analysis and the creation of time attendance time sheets for each employee over the period of time. The time attendance records can be edited, printed, etc. at the computer system 500 as necessary. The software on the computer 500 also enables the employer to track labor costs, insert job codes for billing at different rates to the extent necessary, prepare payroll for the company's employees, etc.

From the foregoing, it will be appreciated by those skilled in the art that the hand-held device comprising a virtual Keytab™ enables a single individual to utilize a single portable, hand-held device to store and transmit a plurality of codes. Such codes can represent different job sites, activities, or even employees if the user is a foreman or the like. The single device replaces the need for the numerous Keytabs™ which would otherwise need to be carried and used. The system of the present invention enables a company to track individual workers' time and charge for their activities and pay the workers in an accurate and easy manner.

Although several embodiments have been described in detail for purposes of illustration, various modifications may be made without departing from the scope and spirit of the invention. Accordingly, the invention is not to be limited, except as by the appended claims.

What is claimed is:

1. A time and activity tracking system, comprising:
a hand-held device comprising an electronic circuit including a memory storing a plurality of unique codes, each unique code corresponding to a user or the hand-held device as well as an activity of a plurality of activities, an actuator adapted to select an activity of the plurality of activities stored in the memory, a display for displaying a human readable activity as the activity is selected, and a data transmitter for transmitting the unique code; and
an electronic time clock comprising a data receiver for receiving the unique code transmitted by the data transmitter of the hand-held device, an internal clock, and a memory for storing the received unique codes and associated time.

2. The system of claim 1, wherein the actuator of the hand-held device comprises a scroll wheel adapted to scroll through a list of activities.

3. The system of claim 2, wherein a human readable activity text is displayed on the display as each activity is scrolled through.

4. The system of claim 1, wherein the hand-held device includes an attachment for a key ring.

5. The system of claim 1, wherein the data transmitter of the hand-held device comprises a conductive member adapted to be placed in direct contact with the receiver of the time clock to transmit the identification and activity codes.

6. The system of claim 5, wherein the conductive member comprises a metallic can having an integrated circuit therein and having a data contact in conductive connection with a lid or base of the can, and a ground contact in conductive connection with the corresponding lid or base of the can.

7. The system of claim 1, wherein the receiver of the time clock comprises a conductive receptor adapted for direct contact with a conductive member of the hand-held device for transfer of data between the hand-held device and the time clock.

8. The system of claim 1, wherein the electronic time clock is adapted to create and associate a time stamp with the unique code as a file.

9. The system of claim 8, including a billing processor for receiving files from the electronic clock and creating time and activity records for each unique code over a predetermined period of time.

10. A device for use in tracking time and activities, comprising: a hand-held housing;
an electronic circuit disposed within the housing and having a memory for storing a plurality of unique codes, each code corresponding to an activity as well as the identity of a user or the device;
an actuator for selecting an activity;
a display for displaying the selected activity in human readable form; and
a data transmitter comprising a conductive member in electrical connection to the electronic circuit and adapted to be placed into contact with and transmit the selected unique code to a conductive receptor of an electronic time clock.

11. The device of claim 10, wherein the actuator of the hand-held device comprises a scroll wheel adapted to selectively scroll through a list of activities.

12. The device of claim 11, wherein a human readable activity is displayed on the display as each activity is scrolled through.

13. The device of claim 10, wherein the hand-held device includes an attachment for a key ring.

14. The device of claim 10, wherein the conductive member comprises a metallic can having an integrated circuit therein and having a data contact in conductive connection with a lid or base of the can, and a ground contact in conductive connection with the corresponding lid or base of the can.

15. The device of claim 10, wherein the display comprises a single line display for displaying a single selected activity at a time.

16. A method for tracking time and activities, comprising the steps of:
providing a hand-held device storing a plurality of unique codes, each code corresponding to the hand-held device or user identity as well as an activity;
selecting an activity from a plurality of activities using an actuator of the device; and
transmitting the selected unique code to an electronic time clock.

17. The method of claim 16, including the step of displaying the selected activity on a display of the device.

18. The method of claim 16, including the step of associating a time stamp with the transmitted unique code.

19. The method of claim 18, including the step of storing the time stamp, transmitted unique code as a file.

20. The method of claim 19, including the steps of transferring the stored file from the electronic time clock to a central billing processor and creating time and activity records relating to each unique code over a predetermined period of time.

21. The method of claim 16, wherein the selecting step comprises the step of rotating a scroll wheel to select an activity from a list of activities.

22. The method of claim 16, wherein the transmitting step comprises the step of moving a conductive transmitter member of the hand-held device into contact with a conductive receiver member of the electronic time clock.
